(19) United States
(12) Patent Application Publication
(10) Pub. No.: US 2017/0146097 A1
(43) Pub. Date: May 25, 2017

(54) TRANSMISSION

(71) Applicant: Schaeffler Technologies AG & Co. KG, Herzogenaurach (DE)

(72) Inventors: Bruno Mueller, Sasbach (DE); Laszlo Man, Ottersweier-Unzhurst (DE); Peter Greb, Ottersweier (DE)

(21) Appl. No.: 15/300,245

(22) PCT Filed: Mar. 19, 2015
(86) PCT No.: PCT/DE2015/200171

§ 371 Date: Sep. 28, 2016

(30) Foreign Application Priority Data
Apr. 2, 2014 (DE) 10 2014 206 303.5

(51) Int. Cl. F16H 3/089; F16H 61/32; F16H 63/18; F16H 3/00; F16H 61/688

(52) U.S. Cl. CPC F16H 3/089; F16H 3/006; F16H 61/688; F16H 63/18; F16H 61/32; F16H 2200/0056; F16H 2061/2869

(57) ABSTRACT

A transmission having a first input shaft, a second input shaft, an output shaft, a first clutch, and a second clutch, wherein each one of the input shafts in connectible to the crankshaft of a drive motor by one of the clutches, wherein each one of the input shafts is connectible to the output shaft by means of gearwheel pairs to transmit torque, wherein a respective actuatable selector fork is provided to connect respective groups of two gearwheel pairs to the input shaft to transmit torque, wherein every gearwheel pair is assigned a transmission ratio, wherein a number of transmission ratios that are gradational relative to one another is provided, wherein the two transmission ratios of a group of gearwheel pairs are a first transmission ratio (N) and the one after the next (N+2), with N an integer number, in particular N=1, 2, 3, 4 or 5.

The invention relates to a transmission, in particular for motor vehicles.

### BACKGROUND

Many types of transmissions for motor vehicles are known in the art. For instance, in what are known as manual transmissions, a clutch may connect the transmission input shaft to a crankshaft of a drive motor, and an output shaft is provided. Between the input shaft and the output shaft, there is a plurality of gearwheel pairs that may be selected by means of a shift lever. In these gearwheel pairs, one of the gearwheels is generally a fixed gearwheel that is firmly connected to the shaft whereas the other gearwheel is a loose gearwheel that is free to rotate on the shaft but connectible for co-rotation therewith by means of a locking mechanism. This may occur by means of the shift lever, a process which is also referred to as engaging a transmission ratio. In this process, the clutch is usually engaged and disengaged by a foot-operated pedal.

Auto shift gearboxes in which the transmission is actuated as described above by means of an actuator in an automated way have also become known in the art. In such a system, the clutch is also actuated in an automated way by means of an actuator.

A disadvantage of these transmissions is that when the transmission ratio is changed, there is a period of time in which no transmission ratio is engaged and consequently no driving torque is applied. Thus shifting operations without interrupting the tractive force are impossible.

For this reason, what are known as double clutch transmissions have become known, which allow transmission ratio changes without interrupting the tractive force. Such transmissions may be actuated by actuators that allow the transmission ratio to be selected and engaged or disengaged as well as the clutch to be operated. These transmissions have two transmission input shafts, which are connectible to a crankshaft of a drive motor by means of two clutches. These transmissions also have an output shaft and a plurality of gearwheel pairs disposed between the two input shafts and the output shaft, allowing a transmission ratio to be engaged simultaneously for each input shaft unless both clutches are engaged at the same time. When the transmission ratio is changed, it is only necessary to disengage one clutch and to engage the other clutch at essentially the same time.

An advantageous actuating device is known, for instance, from the older German Patent Application DE 10 2013 221 058 of the same applicant. This document discloses an actuating device having two roller assemblies, wherein the transmission ratios are actuated by means of selector forks with contacting elements. The contacting elements engage in grooves of the roller assemblies. A change from one groove to another groove is implemented in a direction-of-rotation-dependent way.

### SUMMARY OF THE INVENTION

Prior art transmissions have been found to have different shifting speeds for shifting into higher and lower gears. This results in different shifting times, which may be considered rather inadequate for dynamic shifting cycles, whereas shifting cycles for selected transmission ratio changes are fast if the dynamic aspect seems less important.

An object of the invention is to provide an improved transmission compared to the prior art, in particular in terms of transmission ratio change dynamics.

An exemplary embodiment of the invention relates to a transmission having a first input shaft, a second input shaft, an output shaft, a first clutch, and a second clutch, wherein each one of the input shafts is connectible to the crankshaft of a drive motor by one of the clutches, wherein each one of the input shafts is connectible to the output shaft by means of gearwheel pairs to transmit torque, wherein a respective actuatable selector fork is provided to connect respective groups of two gearwheel pairs to the output shaft to transmit torque, wherein every gearwheel pair is assigned a transmission ratio, wherein a number of transmission ratios that are gradational relative to one another are provided, wherein the two transmission ratios of a group of gearwheel pairs are a first transmission ratio (N) and the one after the next (N+2), with N an integer number, in particular N=1, 2, 3, 4 or 5 etc. As a consequence, to shift down two transmission ratios, i.e. from transmission ratio 3 to transmission ratio 1 and/or from transmission ratio 4 to transmission ratio 2 and/or from transmission ratio 5 to transmission ratio 3 and/or from transmission ratio 6 to transmission ratio 4 and/or from transmission ratio 7 to transmission ratio 5, no complex shifting cycles need to be carried out because the down-shifting is actuated by a selector fork. Thus a short shifting time is achieved in particular for dynamically relevant shifting cycles.

In this context, it is particularly advantageous if the transmission ratios of an input shaft have two groups of gearwheel pairs that comprise the transmission ratios N, N+2, N+4, and N+6, with N an integer, in particular N=1, 2, or 3. This allows even downshifting from transmission ratio N to transmission ratio N−4 to be implemented in a particularly fast way.

In this context, it is advantageous if the transmission ratios of an input shaft have two groups of gearwheel pairs and if these gearwheel pairs comprise transmission ratios 1, 3, 5, and 7.

It is further expedient if the transmission ratios of a first input shaft have two groups of gearwheel pairs, with one group of gearwheel pairs comprising transmission ratios 1 and 3 and another group of transmission ratios comprising transmission ratios 5 and 7.

It is particularly advantageous if the transmission ratios of a first input shaft have two groups of gearwheel pairs and if these gearwheel pairs comprise transmission ratios 2, 4, and 6.

In this context, it is further advantageous if the transmission ratios of the reverse gear R are assigned to one of the gearwheel pairs.

It is particularly advantageous if the transmission ratios of a second input shaft have two groups of gearwheel pairs and if a first group of gearwheel pairs comprises transmission ratios R and 2 and another group of gearwheel pairs comprises transmission ratios 4 and 6.

In accordance with a particularly advantageous aspect, transmission ratios 3, 5 and 2, 4, respectively, of the individual groups may be disposed adjacent to one another on the respective input shaft in the arrangements described above. In this way, shifting cycles from 4 to 2 and from 5 to 3 likewise have correspondingly short shifting times.

In this context, it is advantageous if the gearwheel pairs of at least one of the input shafts or of all input shafts are actuated in pairs by a selector fork, with the selector forks of an input shaft actuated by a respective controller drum.

In accordance with the invention it is likewise advantageous if a respective controller drum is provided to actuate the gearwheel pairs of an input shaft, i.e. if two controller drums are provided to actuate the transmission in the case of two input shafts and the associated gearwheel pairs thereof.

In this context, it is particularly advantageous if each one of the controller drums is driven by a respective electric motor. This allows the transmission to be actuated in a particularly quick and energy-efficient way.

The present invention will be explained in more detail below based on preferred exemplary embodiments in connection with the associated figures.

### BRIEF DESCRIPTION OF THE DRAWINGS

FIG. 1 is a schematic representation of a transmission of the prior art.

FIG. 2 is a schematic representation of a transmission of the invention.

FIG. 3 is a view of a detail of a transmission of the invention.

### DETAILED DESCRIPTION

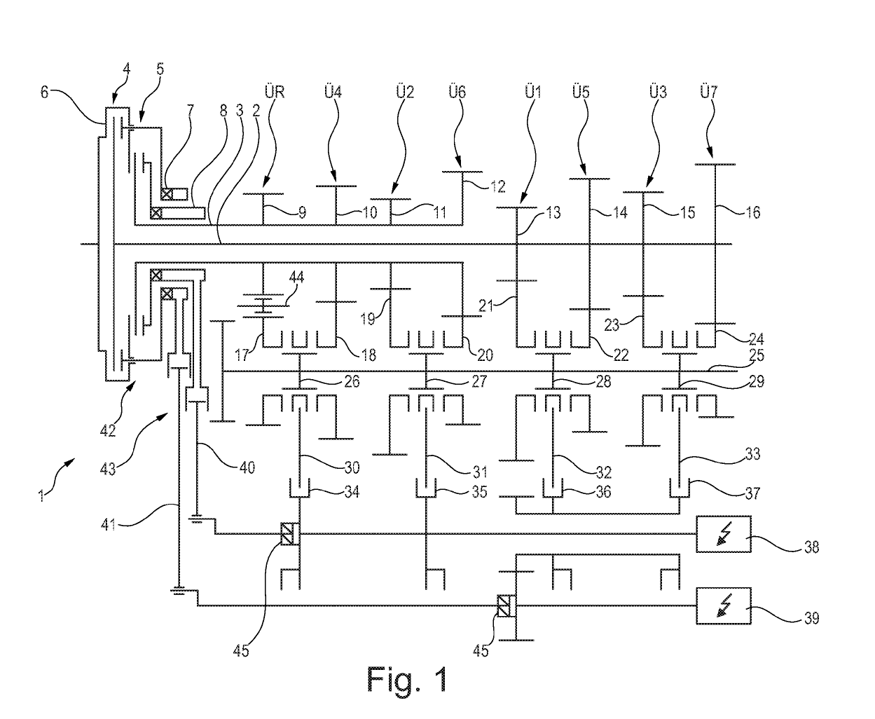

FIG. 1 is a schematic representation of a transmission 1 of the prior art. The transmission 1 includes a first input shaft 2, a second input shaft 3, and clutches 4, 5 for connecting the input shafts 2, 3 to a non-illustrated crankshaft of a drive motor. The clutches 4, 5 are disposed in a clutch housing 6, which is connectible to the crankshaft. Actuation devices 7, 8 are provided to actuate the clutches 4, 5. The actuation devices 7, 8 are actuatable by a control unit to be able to actuate the one clutch 4 and/or the other clutch 5. The input shafts 2, 3 are disposed to be at least coaxial with one another at least in sections, and the actuating devices 7, 8 are preferably likewise disposed to be coaxial with one another. Gearwheels 9, 10, 11, 12, 13, 14, 15, 16 of gearwheel pairs 9/17; 10/18; 11/19; 12/20; 13/21; 14/22; 15/23, and 16/24 are fixed for co-rotation to the two input shafts 2, 3. Gears 9, 10, 11, and 12 are fixed for co-rotation to shaft 3 and gears 13, 14, 15, and 16 are fixed for co-rotation to shaft 2.

Gears 17, 18, 19, 20, 21, 22, 23, 24 are connectible to the output shaft 25, which is disposed to be parallel to the input shafts 2, 3, by selector sleeves 26, 27, 28, and 29. For this purpose, the selector sleeves 26, 27, 28, and 29 are axially movable by selector forks 30, 31, 32, and 33, which are to be moved in one direction or in the other direction in this process. The displacement of the selector forks 30, 31, 32, and 33 is implemented by means of the roller elements 34, 35, 36, and 37, which may be rotated by drive motors 38, 39.

Also, pistons 40, 41 of piston/cylinder units 42, 43 may be actuated by the drive motors 38, 39 to be able to actuate the clutches 4, 5.

The transmission ratios Ü are arranged as follows:

gearwheel pair 13/21 is assigned to the first transmission ratio Ü1,

gearwheel pair 11/19 is assigned to the second transmission ratio Ü2,

gearwheel pair 15/23 is assigned to the third transmission ratio Ü3,

gearwheel pair 10/18 is assigned to the fourth transmission ratio Ü4,

gearwheel pair 14/22 is assigned to the fifth transmission ratio Ü5,

gearwheel pair 12/20 is assigned to the sixth transmission ratio Ü6,

gearwheel pair 16/24 is assigned to the seventh transmission ratio Ü7, and

gearwheel pair 9/17 with an intermediate gearwheel 44 is assigned to the transmission ratio of the reverse gear ÜR. In this context, the transmission ratios Ü1 to Ü7 and ÜR correspond to the known transmission ratios 1 to 7 and R of a transmission, which are also referred to as gears.

It can be seen that the transmission ratios of a group of gearwheel pairs 13/21, 14/22 and 15/23, 16/24, and 11/19, 12/20, respectively, i.e. Ü1, Ü5 and Ü3, Ü7 and Ü2, Ü6, respectively, have a transmission ratio leap of 4, i.e. N and N+4. Thus to shift down from N to N−2, two groups of gearwheel pairs need to be involved. For instance, to shift down from Ü3 to Ü1, the group of gearwheel pairs 13/21 and 14/22 as well as the group of gearwheel pairs 15/23 and 16/24 need to be involved; in this process, the selector sleeve of gearwheel pair 15/23 is actuated in a disengaging way and the selector sleeve of gearwheel pair 13/21 is actuated in an engaging way. To shift down from Ü7 to Ü5, both gearwheel pair groups 13/21 and 14/22 as well as 15/23 and 16/24 are involved.

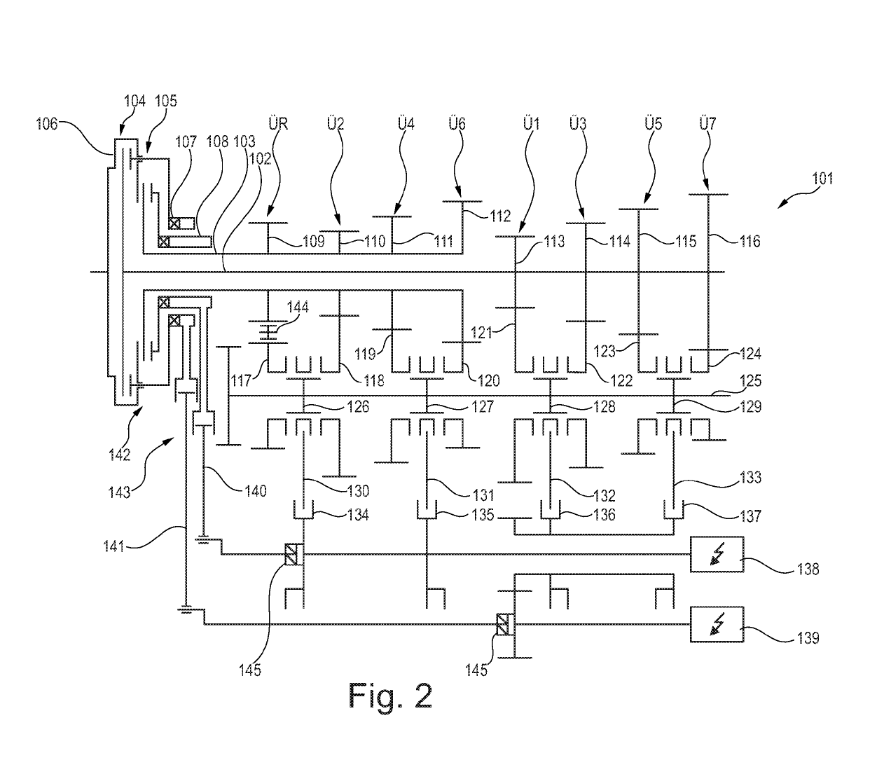

FIG. 2 is a diagrammatic representation of a transmission 101 of the invention. The transmission 101 has a first input shaft 102, a second input shaft 103, and clutches 104, 105 for connecting the first and second input shafts 101, 102 to a non-illustrated crankshaft of a drive motor. The clutches 104, 105 are disposed in a clutch housing 106, which is connectible to the crankshaft. To operate the clutches 104, 105, actuating devices 107, 108 are provided. The actuating devices 107, 108 are controllable by a control unit to actuate one clutch 104 and/or the other clutch 105.

The input shafts 102, 103 are disposed to be coaxial with one another at least in sections, and the actuating devices 107, 108 are preferably likewise disposed to be coaxial with one another. Gearwheels 109, 110, 111, 112, 113, 114, 115, 116 of gearwheel pairs 109/117; 110/118; 111/119; 112/120; 113/121; 114/122; 115/123 and 116/124 are fixed for co-rotation to the two input shafts 102, 103. Gearwheels 109, 110, 111, and 112 are fixed for co-rotation to shaft 103 and gearwheels 113, 114, 115, and 116 are fixed for co-rotation to shaft 102.

Gearwheels 117, 118, 119, 120, 121, 122, 123, 124 are connectible to the output shaft 125, which is disposed to be parallel to the input shafts 102, 103, by means of selector sleeves 126, 127, 128, and 129. For this purpose, the selector sleeves 126, 127, 128, and 129 are axially movable by selector forks 130, 131, 132, and 133, which are to be moved in one direction or in the other direction in this process. The displacement of the selector forks 130, 131, 132, and 133 is implemented by the roller elements 134, 135, 136, and 137, which may be rotated by drive motors 138, 139, for instance electric or hydraulic motors. Roller elements 134, 135 and 136, 137, respectively, may be combined to form a respective controller drum.

Also, pistons 140, 141 of piston/cylinder units 142, 143 may be actuated by the drive motors 138, 139 to be able to actuate the clutches 104, 105.

The transmission ratios Ü are arranged as follows:

gearwheel pair 113/121 is assigned to the first transmission ratio Ü1,

gearwheel pair 110/118 is assigned to the second transmission ratio Ü2,

gearwheel pair 114/122 is assigned to the third transmission ratio Ü3,

gearwheel pair 111/119 is assigned to the fourth transmission ratio Ü4,

gearwheel pair 115/123 is assigned to the fifth transmission ratio Ü5,

gearwheel pair 112/120 is assigned to the sixth transmission ratio Ü6,

gearwheel pair 116/124 is assigned to the seventh transmission ratio Ü7, and

gearwheel pair 109/117 with an intermediate gearwheel 144 is assigned to the transmission ratio of the reverse gear ÜR. In this context, the transmission ratios Ü1 to Ü7 and ÜR correspond to the known transmission ratios 1 to 7 and R of a transmission, which are also referred to as gears.

It can be seen in FIG. 2 that the transmission ratios of a group of gearwheel pairs 113/121, 114/122 and 115/123, 116/124, and 111/119, 112/120, respectively, i.e. Ü1, Ü3 and Ü5, Ü7 and Ü4, Ü6, respectively, have a transmission ratio leap of only two, i.e. N and N+2. Thus to shift down from N to N−2, only one gearwheel pair group is involved. This accelerates the shifting cycle, in particular if roller elements are used for actuation. For instance, to shift down from Ü3 to Ü1, only the group of gearwheel pairs 113/121 and 114/122 is involved; to shift down from Ü7 to Ü5, only the group of gearwheels 115/123 and 116/124 is involved.

A respective freewheel 45, 145 is provided between the respective drive motor 38, 39 and 138, 139, respectively, and the piston.

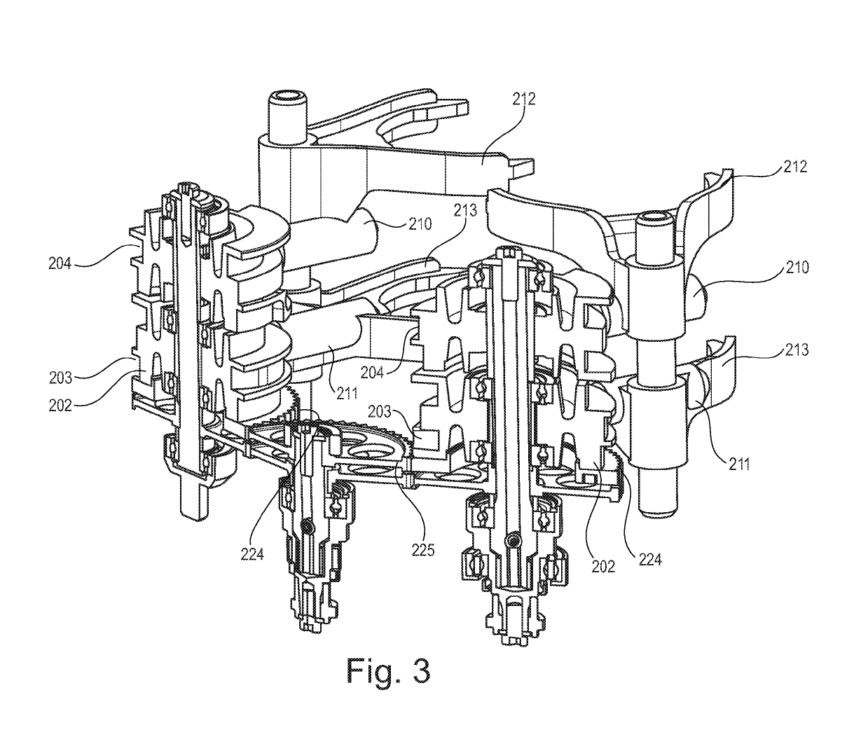

FIG. 3 is a sectional view of the arrangement of two roller elements 202 with a gearwheel 224 for driving purposes via a drive unit 225, wherein the contact elements 210, 211 of the selector forks 212, 213 engage in the guide tracks 203, 204 and are movable in the guide tracks by rotating the roller elements 202.

Thus the gearwheel pairs of at least one of the input shafts or of all input shafts may be actuated in pairs by means of one of the selector forks 212, 213. The selector forks 212, 213 of an input shaft may be actuated by a respective controller drum as the roller unit 202. A respective controller drum as the roller element 202 is provided to actuate the gearwheel pairs of an input shaft, and for two input shafts and the associated gearwheel pairs, two controller drums as the roller elements 202 are provided to actuate the transmission. The controller drums as the roller elements 202 are preferably driven by one electric motor or by respective electric motors.

In this respect and in particular in terms of the actuation of the clutch, reference is made to the older application DE 10 2013 221 058, whose disclosed content is hereby expressly incorporated in its entirety by reference herein.

### LIST OF REFERENCE SYMBOLS

1 transmission
2 input shaft
3 input shaft
4 clutch
5 clutch
6 clutch housing
7 actuating device
8 actuating device
9 gearwheel
10 gearwheel
11 gearwheel
12 gearwheel
13 gearwheel
14 gearwheel
15 gearwheel
16 gearwheel
17 gearwheel
18 gearwheel
19 gearwheel
20 gearwheel
21 gearwheel
22 gearwheel
23 gearwheel
24 gearwheel
25 output shaft
26 selector sleeve
27 selector sleeve
28 selector sleeve
29 selector sleeve
30 selector fork
31 selector fork
32 selector fork
33 selector fork
34 roller element
35 roller element
36 roller element
37 roller element
38 drive motor
39 drive motor
40 piston
41 piston
42 piston-cylinder unit
43 piston-cylinder unit
44 intermediate gearwheel
45 freewheel
101 transmission
102 input shaft
103 input shaft
104 clutch
105 clutch
106 clutch housing
107 actuating device
108 actuating device
109 gearwheel
110 gearwheel
111 gearwheel
112 gearwheel
113 gearwheel
114 gearwheel
115 gearwheel
116 gearwheel
117 gearwheel
118 gearwheel
119 gearwheel
120 gearwheel
121 gearwheel
122 gearwheel
123 gearwheel
124 gearwheel
125 output shaft
126 selector sleeve
127 selector sleeve
128 selector sleeve
129 selector sleeve
130 selector fork
131 selector fork
132 selector fork
133 selector fork
134 roller element
135 roller element
136 roller element
137 roller element
138 drive motor
139 drive motor
140 piston
141 piston
142 piston-cylinder unit
143 piston-cylinder unit
144 intermediate gearwheel
145 freewheel
202 roller element
203 guide track
204 guide track
210 contact element
211 contact element
212 selector fork
213 selector fork
224 gearwheel
225 driving stage

What is claimed is:

1-12. (canceled)

13. A transmission comprising:
a first input shaft;
a second input shaft;
an output shaft;
a first clutch; and
a second clutch, wherein each one of the first and second input shafts is connectible to the crankshaft of a drive motor by one of the first and second clutches, wherein each one of the first and second input shafts is connectible to the output shaft by gearwheel pairs to transmit torque, wherein a respective actuatable selector fork is provided to connect respective groups of two gearwheel pairs of the gearwheel pairs to the output shaft to transmit torque, wherein each gearwheel pair is assigned a transmission ratio, wherein a number of transmission ratios gradational relative to one another is provided, the two transmission ratios of a group of gearwheel pairs being a first transmission ratio (N) and the one after the next (N+2), with N an integer.

14. The transmission as recited in claim 13 wherein N=1, 2, 3, 4 or 5.

15. The transmission recited in claim 13 wherein the transmission ratios of one of the first and second input shafts have two groups of the gearwheel pairs, wherein the two groups of gearwheel pairs comprising the transmission ratios N, N+2, N+4, and N+6.

16. The transmission recited in claim 15 wherein N=1, 2, or 3.

17. The transmission recited in claim 13 wherein the transmission ratios of one of the first and second input shafts have two groups of the gearwheel pairs, wherein the two groups of the gearwheel pairs comprising transmission ratios 1, 3, 5, and 7.

18. The transmission as recited in claim 17 wherein the gearwheel pairs comprise transmission ratios 1 and 3 in one of the two groups as well as transmission ratios 5 and 7 in the other of the two groups.

19. The transmission recited in claim 18 wherein the two groups of gearwheel pairs follow one another on the input shaft in such a way that the transmission ratios 3 and 5 are adjacent to one another.

20. The transmission recited in claim 13 wherein the transmission ratios of one of the first and second input shafts have two groups of the gearwheel pairs, wherein the two groups of the gearwheel pairs comprising transmission ratios 2, 4, and 6.

21. The transmission recited in claim 13 wherein the transmission ratio R of a reverse gear is assigned to one of the gearwheel pairs.

22. The transmission recited in claim 21 wherein the transmission ratios of one of the input shaft have two groups of the gearwheel pairs, wherein the two groups of the gearwheel pairs comprise transmission ratios R and 2 in one group and the transmission ratios 4 and 6 in another group.

23. The transmission recited in claim 22 wherein the two groups of gearwheel pairs follow one another on the input shaft in such a way that the transmission ratios 2 and 4 are adjacent to one another.

24. The transmission recited in claim 13 wherein the gearwheel pairs of at least one of the first and second input shafts are actuated in pairs by a selector fork, the selector forks of the at least one of the first and second input shafts being actuated by a respective controller drum.

25. The transmission recited in claim 13 wherein a respective controller drum is provided to actuate the gearwheel pairs of one of the first and second input shafts and that for both the first and second input shafts and the associated gearwheel pairs thereof two controller drums are provided to actuate the transmission.

26. The transmission recited in claim 13 wherein each one of the controller drums is driven by a respective electric motor.
